(19) United States
(12) Patent Application Publication
(10) Pub. No.: US 2024/0116616 A1
(43) Pub. Date: Apr. 11, 2024

(54) MOUNTING DEVICE FOR A LEVER CONFIGURED FOR CONTROLLING A MARINE VEHICLE

(71) Applicants: ZF Friedrichshafen AG, Friedrichshafen (DE); ZF Padova S.r.l., Caselle die Selvazzano (PD) (IT)

(72) Inventors: Paolo Moruzzi, Caselle di Selvazzano(PD) (IT); Massimo Tranquillini, Mori (TN) (IT); Ferruccio Basurto, Caselle di Selvazzano (PD) (IT); Gianluca Straccio, Caselle di Selvazzano (PD) (IT); Danilo Selvaggi, Caselle di Selvazzano (PD) (IT)

(73) Assignees: ZF Friedrichshafen AG, Friedrichshafen (DE); ZF Padova S.r.l., Caselle die Selvazzano (PD) (IT)

(21) Appl. No.: 18/480,770

(22) Filed: Oct. 4, 2023

(30) Foreign Application Priority Data
Oct. 10, 2022 (EP) 22200678.5

(51) Int. Cl. B63H 21/21

(52) U.S. Cl. CPC B63H 21/213; B63H 2021/216

(57) ABSTRACT

The present invention relates to a mounting device (30) for a lever (10) configured for controlling a marine vessel. The mounting device (30) is configured to hold a lever element (14) rotatably about a rotation axis (32) and to adjust an amount of resistance against moving the lever element (14) depending on an angular lever position. In a first angular lever position range, the amount of resistance against further angular deflection increases with an increased deflection of the lever element (14) beyond a neutral position. The present invention further relates to a lever (10) configured for controlling a marine vessel and to a marine vessel.

### TECHNICAL FIELD

The present invention relates to a mounting device for a lever configured for controlling a marine vessel. Further, the invention relates to a lever configured for controlling a marine vessel and to a marine vessel.

### PRIOR ART

Levers can be used for controlling marine vessels. For example, the lever may be convenient for controlling a power train of the marine vessel. In such an example, the thrust generated by a part of the power train may be proportional to an angular lever position. In a neutral position, an engine may be set to idling and a clutch may be in an open state. Adjusting the lever into a more forward position may first cause a gear for forward movement to engage, for example by closing a clutch. Further adjusting the lever forward may increase an engine output and thus forward thrust. Moving the lever backward may first cause a different gear for backward movement to engage, for example by closing a different clutch. Further adjusting the lever backwards may increase an engine output and thus backward thrust.

For intuitive control of the vessel, it is helpful to give tactile feedback to the operator. For example, due to an inherent sluggishness caused by high inertia of marine vessels, an operator may otherwise be unsure whether an appropriate gear has been engaged or disengaged and whether a rather high or low amount of thrust has been commanded. Insufficient or even complete lack of tactile feedback may make it difficult for the operator to appropriately control the vessel. Further, the operator may feel the need to visually confirm lever position, thus distracting the operator from the environment and from steering the vessel.

WO 2006/063379 A1 describes an optical potentiometer and control lever assembly. The lever comprises a ball, a spring and a plurality of detents within an arcuate block. This is said to provide a degree of feel to movement of the lever and to make it easier to stop the lever in a desired position.

U.S. Pat. No. 9,272,764 B2 describes a remote control device for a vessel and a remote control method for a vessel propulsion device. An operation load applying mechanism that applies an operation load to an operation lever includes a detent roller, a roller presser member, a detent spring and an actuator.

### SUMMARY OF THE INVENTION

A first aspect relates to a mounting device for a lever configured for controlling a marine vessel. The marine vessel may, for example, be configured as a speedboat, yacht or special purpose ship. The marine vessel may comprise a power train configured to provide thrust for the vessel. For example, the marine vessel may comprise an outboard motor with a gear box and an engine. The mounting device may form a base of the lever or may connect such a base to a lever element. The base may be configured for mounting to the vessel. The mounting device may be configured to hold a lever element. The lever element may be configured for actuation by an operator, for example with a hand to adjust its position. The mounting device is configured to hold the lever element rotatably about a rotation axis. For example, the lever element may be tilted forward or backward to comment a power train of the marine vessel.

The mounting device is configured to adjust an amount of resistance against moving the lever element depending on an angular lever position. In different lever positions, resistance against rotating the lever element further may thus be different. The resistance may be a resistance in just one direction of rotation, such as further deflection away from a neutral position, or in both directions of rotation. Such a configuration provides additional tactile feedback when actuating the lever, providing the operator with non-discrete information about the lever element position. By comparison, detents only provide the operator position information at discrete lever angles and in case of a plurality of detents, may actually leave the operator in doubt about the position.

In a first angular lever position range, the amount of resistance against further angular deflection increases with an increased deflection of the lever element beyond a neutral position. For example, the further the lever element has been pushed forward, the more force is necessary to rotate the lever element further in the forward direction. Such tactile feedback is very intuitive for the operator. Further, such tactile feedback may provide the operator with position information at any angular lever position. In addition, such a force increase may also increase safety since high angles of deflection beyond the neutral position require comparatively high actuation forces, thus reducing the risk of accidentally moving the lever element to a very extreme position. The mounting device provides a unique relationship between the angle of the lever element and a torque needed to rotate the lever element. The mounting device may be very cost-effective due to using mostly standard parts instead of customized components. Further, the mounting device and thus the lever may be very small and have a low number of parts.

The mounting device may be configured for movement of the lever element about the rotation axis away from the neutral position in one or two directions. In the case of two directions, the mounting device may have two first angular position ranges, each one corresponding to one direction beyond the neutral position. The lever element may be a plastic part. The lever element may have a central shaft at one end. The rotation axis may be coaxial with the central shaft. The neutral position may correspond to a certain angular lever position. The neutral position may also correspond to a certain angular lever position range, for example extending 5°, 10°, 15°, 20° or even 25° in one or both directions of rotation. The first angular lever position range may be corresponding to an angle different to one corresponding to the neutral position. For example, the first angular lever position range may be a range larger than 5°, 10°, 15°, 20° or even 25°, depending on the angular range of the neutral position. The first angular lever position range may extend up to a maximum deflection of the lever element or some other angle, after which a second angular lever position may start.

In a further embodiment of the mounting device according to the first aspect, the mounting device comprises a first mounting element, a second mounting element and a first spring element. One of the two mounting elements may be configured for mounting to the vehicle, for example for fixed mounting to the vehicle. The other of the two mounting elements may be moveably attached to the other mounting element. Said mounting element may be configured for attachment of the lever element.

The lever may therefore comprise a stick element attached to one mounting element that is moveably supported by a base with the other mounting element. The spring element may be configured as a compression spring. For example, the spring element may be configured as coil spring, such as a metal coil spring.

The two mounting elements are rotatable relative to each other to allow a rotation of lever element about the rotation axis, for example by being rotatably attached to each other. One of the two mounting elements may be rotationally fixed to the lever element. For example, the one of the two mounting elements connected to the lever element may rotate together with the lever element. Actuating the lever element may cause the relative movement of the two mounting elements. For example, the rotation axis may extend sideways through the lever and coaxial with a central shaft. The rotation axis may be an axis of symmetry of the mounting device or might be off-set from such an axis of symmetry. The mounting device may be configured to allow relative rotation away from the neutral position in two directions, such as the forward and the backward direction, or just one direction. When mounted to the marine vessel, the rotation axis usually extends substantially horizontally, for example in the left-right direction of the vessel. The neutral position may be a position in which the lever does not generate any adjustment signal for the vessel function controlled by the lever. For example, in the neutral position, a propulsion system of the vessel does not create any thrust. The lever may be configured to automatically return the lever element to the neutral position upon its release or may be configured to let the lever element remain in the position in which it has been released.

The first mounting element may be mounted axially moveably along the rotation axis. For example, the first mounting element may be shifted to the right or left. For example, the first mounting element may be slideably mounted to the central shaft. A first section of a contact surface of at least one of the two mounting elements contacting the other of the two mounting elements in the first angular lever position range is shaped so that rotation of the lever element about the rotation axis causes a change in tension in the first spring element in the first angular lever position range. Such a configuration provides a cost-effective dependency of the movement resistance of the lever on the angular position of the lever element. Further, such a configuration may require a low number of parts and may be very reliable. For example, the spring element may be configured to urge the first mounting element with its contact surface against the second mounting element. The mounting device may be configured so that the two mounting elements remain in touch in any relative angular position.

For example, the first section of the contact surface may be inclined so as to move the two mounting elements away from each other the further the lever element is deflected beyond the neutral position. The resulting axial movement of the first mounting element away from the second mounting element may cause the spring element to compress. A higher resistance towards further relative rotation may be the result of further compression of the spring element.

The first spring element may be preloaded in every angular position of the lever element. Such a configuration may ensure smooth lever actuation and may prevent a leaping change in movement resistance. The contact surface may be an annular surface or section thereof, for example radially extending around the rotation axis. Both mounting elements may have a contact surface. The two contact surfaces may be shaped identically, mirror symmetrical to each other or differently. The mounting elements may each be symmetrical with respect to the rotation axis. The second mounting element may be fixed in position rotationally about the rotation axis and additionally or alternatively axially along the rotation axis. The two mounting elements may be plastic parts, for example manufactured in an injection-molding process. The first mounting element and alternatively or additionally the second mounting element may be configured as a bushing. The two mounting elements may be lightweight and cost-effective to manufacture. Compared to other mounting devices, the present mounting device may have a low number of parts.

Resistance to moving the lever may easily be adapted by changing the shape of the contact surface. Further, the amount of resistance may also be adapted by changing the spring element and additionally or alternatively by providing additional spring elements. For example, with a higher number of first spring elements, the mounting device may have a very small longitudinal extension along the axis of rotation.

For example, any first spring element may be arranged between the first mounting element and either the lever element or the base. The first spring element may be configured to urge the first mounting element against the second mounting element. The spring element may be fixed with one end to the first mounting element. The first spring element may also just be arranged adjacent a spring support surface of the first mounting element. The first spring element may be facing away from the second mounting element with its other end, for example if the first spring element is configured as a compression spring. The first spring element may be received in a blind hole of the first mounting element. The first spring element may extend from the blind hole towards the lever element and alternatively or additionally the base. The first spring element may be arranged eccentrically to the axis of rotation. The first spring element may be arranged spaced apart to the axis of rotation. The first spring element may extend parallel to the axis of rotation and additionally or alternatively the central shaft. The first spring element may be tensioned in any position of the first mounting element relative to the second mounting element.

In a further embodiment of the mounting device according to the first aspect, the first section of the contact surface is shaped to axially move the first mounting element away from the second mounting element with an increase in deflection of the lever element beyond the neutral position in the first angular lever position range. Such a configuration may result in reliable first spring element compression.

In a further embodiment of the mounting device according to the first aspect, the first section of the contact surface is inclined towards the other one of the two mounting elements. For example, when starting from a section of the contact surface corresponding to the neutral section, the first section may be sloped towards the other one of the two mounting elements. The first section of the contact surface may be inclined relatively to the rotation axis. The first section of the contact surface may be planar or curved. For example, the inclination may increase the further the surface is away from a section corresponding to the neutral position or the inclination may remain constant. The contact surface may comprise several inclined surface parts. The contact surface may also comprise non-inclined parts, such as at a section which extends orthogonally to the axis of rotation and additionally or alternatively parallel to the corresponding contact surface of the other mounting element.

In a further embodiment of the mounting device according to the first aspect, each of the two mounting elements has a contact surface with a first section, wherein the two first sections contact each other in the first angular lever position. Such a configuration may have a high transmission ratio that results in large axial movement of the first mounting element when turning the lever. Correspondingly, torque required for actuating the lever ramps up quickly. Such a configuration may be very compact. For example, the first section of the contact surface of each mounting element may be inclined towards the other one of the mounting elements.

In a further embodiment of the mounting device according to the first aspect, in a second angular lever position range, the amount of resistance is substantially constant regardless of the deflection of the lever element from the neutral position. Said second angular lever position range may correspond to the neutral position or some other angular position range different to the first angular position range. The operator may thus, for example, not require additional force to move the lever until a clutch has been engaged. For example, a second angular lever position range may follow directly after the first angular lever position range. This may provide the operator with further tactile feedback, for example indicating that the lever element has been rotated close to an end stop or to a position that will cause a special vessel function to be executed. There may be several second angular position ranges.

In a further embodiment of the mounting device according to the first aspect, a second section of the contact surface contacting the other of the two mounting elements in the second angular lever position range is shaped so that rotation of the lever element about the rotation axis causes substantially no change in tension in the first spring element in the second angular lever position range. For example, said second section may be shaped to be parallel to a corresponding contact surface of the other mounting element the second section of the contact surface touches in the second angular lever position range. For example, the second section of the contact surface may extend orthogonally to the rotation axis. The second section of the contact surface may be shaped to not axially move the first mounting element away from or towards the second mounting element with an increase in deflection of the lever out of the neutral position in the second angular lever position range. The two mounting elements may therefore keep their axial distance in the second angular lever position range. Each of the two mounting elements may have a contact surface with a second section, wherein the two second sections contact each other in the second angular lever position.

In a further embodiment of the mounting device according to the first aspect, the second section of the contact surface extends substantially orthogonally to the rotation axis. For example, the second section may not be inclined towards or away from the other mounting element. Such a second section may be particular cost-effective to manufacture.

In a further embodiment of the mounting device according to the first aspect, the mounting device is configured to provide a detent at the neutral position of the lever element. A detent may be a tactile feedback for a certain angular position. For example, the operator may briefly require additional force to move the lever element beyond the detent. Similarly, upon arrival, the detent may briefly stop lever element rotational movement. Additionally or alternatively, the detent may provide a small mechanical shock as tactile feedback for the operator. Additionally or alternatively, the detent may provide acoustic feedback. For example, the mounting device may provide a detent in the middle of a neutral angular lever position range. Additionally or alternatively, a detent may be provided at the edge of the neutral angular lever range, for example in each direction. For example, at such a position, the clutch may be engaged. Alternatively, the clutch may be engaged when deflecting the lever element further into the first angular lever position range. The operator thus may be provided with additional tactile feedback. The mounting device may be configured to provide multiple detents. For example, in case the lever can be rotated in two directions out of the neutral position, a detent can be provided in both directions.

In a further embodiment of the mounting device according to the first aspect, the mounting device comprises a second spring element and a ball element, wherein the second spring element is mounted to one of the two mounting elements and urges the ball element against a ball support surface of the other of the two mounting elements. For example, the second spring element may be arranged between the two mounting elements. The ball element may be a metal or plastic ball, for example configured as a roller typically found in roller bearings. The ball element may, for example, be configured as a sphere or as a cylinder. The ball element may thus be a cost-effective standard component. Similarly, the second spring element may also be a cost-effective standard component. A diameter of the ball element may correspond to a diameter of the second spring element. The ball support surface is shaped to provide respective detents. The mounting device may thus easily and reliably provide the detents. The mounting device may also comprise several second spring elements and corresponding ball elements. The second spring elements may be arranged parallel to the axis of rotation. Such a configuration may be very compact, in particular if the first spring elements are arranged similarly. The second spring elements may be preloaded in any angular position of the lever element.

In a further embodiment of the mounting device according to the first aspect, the ball support surface comprises a recess for each respective detent, wherein the ball element is arranged at least partially in the recess when the lever element is arranged at an angular lever position of the corresponding detent. Such a recess may be provided per detent and per ball element. The recess may be formed, for example, as a blind hole or other form of indentation or through hole in the second mounting element. When reaching a corresponding angular lever position, the second spring element may push the ball element into the recess. Moving the lever element beyond the detent requires the ball to be moved out of the recess, which requires an operator to overcome the resistance of the ball element moving out of the recess against the second spring element.

In a further embodiment of the mounting device according to the first aspect, the ball support surface comprises a recess for each respective detent, wherein the ball element is arranged at least partially in the recess when the lever element is arranged at an angular lever position of the corresponding detent.

A second aspect relates to a lever configured for controlling a marine vessel. The lever comprises a mounting device according to the first aspect. Further, the lever may comprise a lever element, for example rotationally locked to one of the two mounting elements. The lever may have a central shaft extending from the lever element along the rotation axis. The central shaft may be a part of the lever element, such as an integral part. The central shaft may also be formed by a separate part. The mounting device may be mounted to the central shaft, for example with the first mounting element axially moveably but rotationally fixedly mounted to the central shaft.

In a further embodiment of the lever according to the second aspect, the first mounting element is mounted to the central shaft with a spline which allows axial movement but no rotational movement relative to the shaft. Such a connection of the first mounting element may reliably rotationally fix the first mounting element to the lever element. Further, such a connection may be easy and cost-effective to manufacture, such as in an injection molding process.

A third aspect relates to a marine vessel. The marine vessel comprises a lever according to the second aspect and additionally or alternatively a mounting device according to the first aspect. The vessel comprises an engine and a transmission. The engine and transmission may form a part of the power train of the vessel. The engine may, for example, be an electrical or combustion engine. The transmission may comprise one or several clutches. The transmission may be configured to provide different gears, such as a neutral gear, a forward gear and a backward gear. The lever may be configured to control an engine output depending on the angular lever position. The lever may be configured to control a gear engagement of the transmission depending on the angular lever position, for example by actuating a clutch.

Preferred embodiments and expedient developments of one aspect may also constitute preferred embodiments and expedient developments of the other aspects. Other features of the present invention will be apparent from consideration of the information contained above as well as in or in combination with the following detailed description, drawings and claims.

### BRIEF DESCRIPTION OF THE DRAWINGS

FIG. 1 schematically illustrates a lever in a side view.

FIG. 2 schematically illustrates the lever of FIG. 1 in a front way, wherein a mounting device of the lever is shown by partially sectional illustration of the lever.

FIG. 3 schematically illustrates the lever of FIG. 1 in a top view, also showing the mounting device of the lever by partially sectional illustration of the lever.

FIG. 4 schematically illustrates the mounting device in a sectional side view.

FIG. 5 schematically illustrates the mounting device in an exploded view.

FIG. 6 schematically illustrates the lever in its neutral position in a side view.

FIG. 7 schematically illustrates the neutral position in a top view of the mounting device.

FIG. 8 schematically illustrates a detent of the mounting device provided for the neutral position in a sectional side view.

FIG. 9 schematically illustrates the lever in its forward detent position in a side view.

FIG. 10 schematically illustrates the forward detent position in a top view of the mounting device.

FIG. 11 schematically illustrates a detent of the mounting device provided for the forward detent position in a sectional side view.

FIG. 12 schematically illustrates the lever in its forward limit position in a side view.

FIG. 13 schematically illustrates the forward limit position in a top view of the mounting device.

FIG. 14 schematically illustrates the mounting device in the forward limit position in a sectional side view.

### DETAILED DESCRIPTION OF EMBODIMENTS

FIG. 1 shows a lever 10 configured for controlling the power train of a marine vessel. The lever 10 comprises a base 12 and a lever element 14 on its left and its right side. The base 12 is bolted to a deck 16 of the marine vessel. One of each of the two lever elements 14 is rotatably mounted to one side of the base 12. Each lever element 14 may control thrust provided by a corresponding engine. For sake of simplicity, the following description will only refer to the lever element 14 and its mounting, which equally applies to both lever elements 14.

FIG. 1 shows the lever element 14 in a neutral position. In the neutral position, the engine is idling and a transmission is in a neutral gear. The neutral position has a forward angular lever position range of 15°, which is illustrated with arrow 18. Once the lever element 14 has been pushed forward by those 15°, which corresponds to the direction of arrow 20, the transmission will engage a forward gear, in the present example by closing an appropriate clutch. Similarly, the neutral position has a backward angular lever position range of 15°, which is illustrated with arrow 22. Once the lever element 14 has been pushed backward by those 15°, which corresponds to the direction of arrow 24, the transmission will engage a backward gear, in the present example by closing an appropriate clutch. The lever 10 is configured to provide a detent at the angular lever position at the end of the neutral position range in both directions of rotation, so that an operator receives tactile feedback when the respective gear is engaged. Further, there is a detent at the middle of the neutral position range.

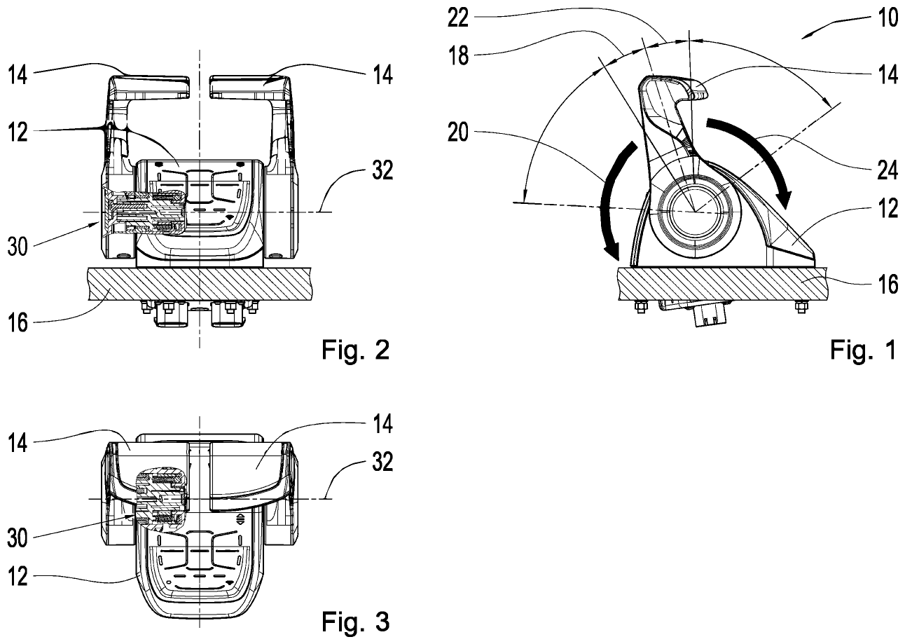

A mounting device 30 holds the lever element 14 rotatably about a rotation axis 32 on the base 12. Said rotation axis can best be seen in FIG. 2 and FIG. 3. The mounting device 30 is configured to adjust an amount of resistance against moving the lever element depending on an angular lever position. In the neutral angular position range, the resistance is constant. In a first angular lever position range, the amount of resistance against further angular deflection increases with an increased deflection of the lever element 14 beyond a neutral position. For example, once the lever element 14 has been pushed forward by more than 15°, a resistance against pushing the lever element 14 further forward continuously increases with each degree the lever element 14 is rotated more forward. An operator will thus require a larger torque to move the lever element 14 further in an extreme position. This gives tactile feedback that continuously corresponds to an angle of a stick of the lever 10. The mounting device 30 also provides the detents discussed above.

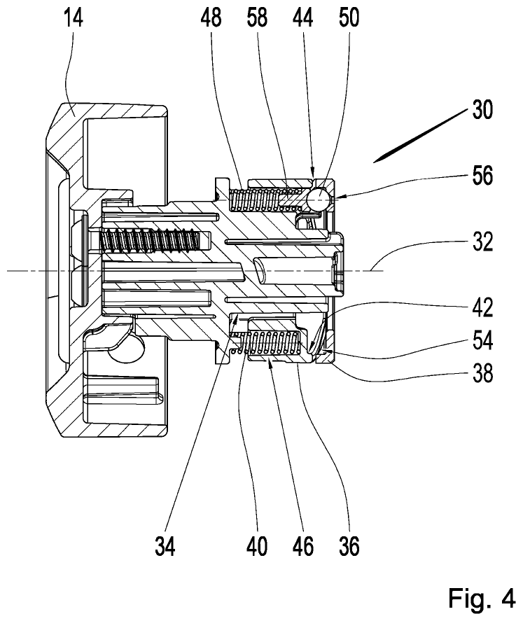

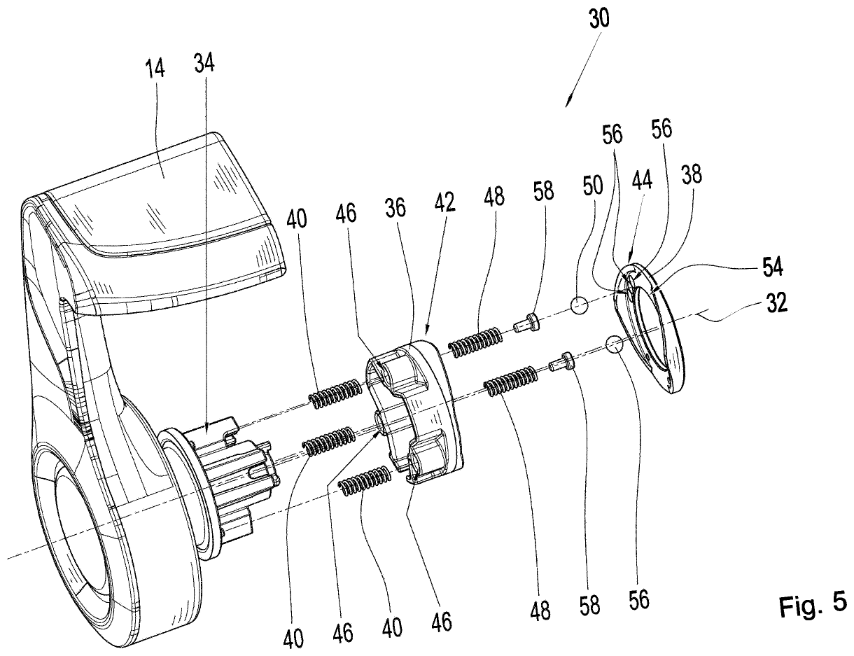

The details of the mounting device 30 are illustrated in FIG. 4 and FIG. 5. As can be seen, the lever element 14 comprises a central shaft 34 that extends from one end of a grip portion of the lever element 14. FIG. 4 also shows that the grip portion of the lever element 14 is secured with screws to the central shaft 34. The central shaft 34 is coaxial with the rotation axis 32. The lever element 14 is rotatably mounted to the base 12 with the central shaft 34. On its exterior circumferential surface, the central shaft 34 forms a spline. The mounting device further comprises a first mounting element 36 and a second mounting element 38, which are rotatably relative to each other. The first mounting element 36 is rotatably fixed to the central shaft 34 and thus the lever element 14 with a through hole having an interior circumferential surface corresponding to the spline. The first mounting element 36 is mounted axially moveable along the rotation axis 32 and the central shaft 34. The second mounting element 38 is fixed to the base 12.

Further, the mounting device comprises a set of three first spring elements 40 configured as compression springs. The first spring elements 40 are circumferentially spaced around the central axis 32. The first spring elements 40 are arranged between the first mounting element 36 and the lever element 14. The first spring elements 40 are received with one end in corresponding blind holes 46 of the first mounting element 36 and are resting with another end on a part of the lever element 14, in the present example being supported by a radial ledge of the central shaft 34. The first spring elements 40 urge the first mounting element 36 axially against the second mounting element 38. The first mounting element 36 has an annular first contact surface 42 formed around a most radially outward part of the first mounting element 36. The first contact surface 42 is facing towards the second mounting element 38 in the direction of the rotation axis 32. The first spring elements 40 urge the first mounting element 36 axially against the second mounting element 38. The second mounting element 38 has a corresponding annular second contact surface 44 formed around a most radially outward part of the second mounting element 38. The second contact surface 44 is facing towards the first mounting element 36 in the direction of the rotation axis 32. The two contact surfaces are at least partially resting on each other in any angular lever position.

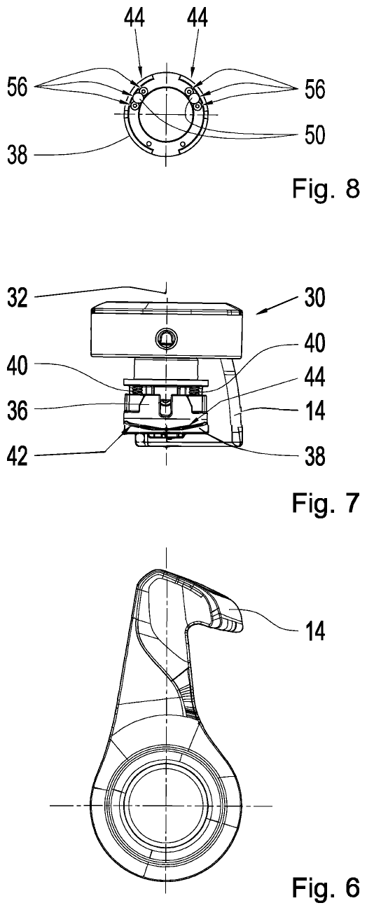

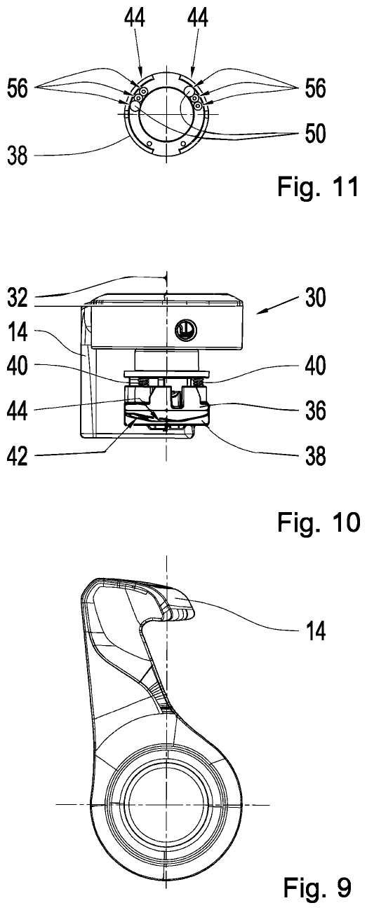

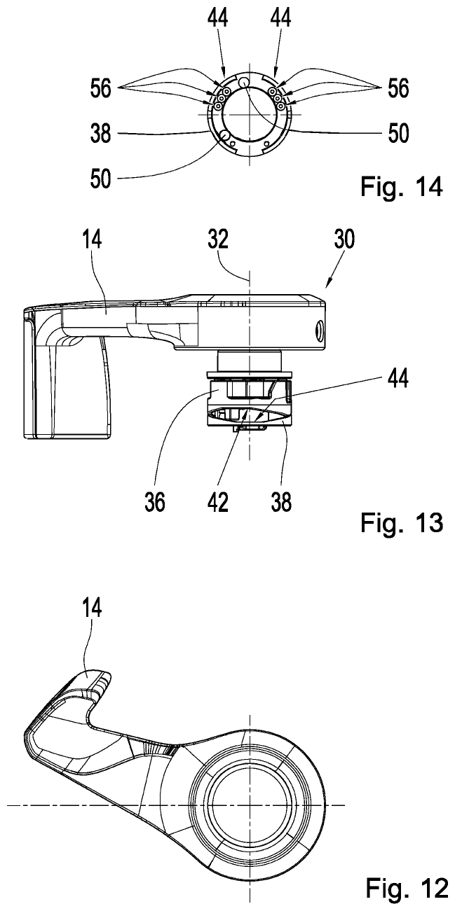

The combination of the first spring elements 40 and the two contact surfaces 42, 44 cause a change in resistance against angular deflection depending on the angular position of the lever element 14. Attention is drawn to FIG. 6, FIG. 7, FIG. 9, FIG. 10, FIG. 12 and FIG. 13 for further understanding. FIG. 6 shows the lever element 14 in an upright neutral position. As can be seen in FIG. 7, each section of the contact surfaces 42, 44 touching each other are also parallel to each other. When moving the lever element 14 forward, as illustrated in FIG. 9 and FIG. 12, a first section of the first contact surface 42 that is inclined towards the second mounting element 38 and a first section of the second contact surface 44 that is inclined towards the first mounting element 38 are rotated in contact with each other. This causes the first mounting element 36 to axially move towards the lever element 14 and away from the second mounting element 38. As a result, the first spring elements 40 are compressed. Hence, the operator does not only need to actuate the lever element 14 with enough force to overcome a frictional resistance but also to compress the spring elements 40. The first section of the two contact surfaces 42, 44 contacting each other in the first angular lever position range beyond the neutral position are thus shaped so that rotation of the lever element 14 about the rotation axis 32 causes a change in tension in the first spring elements 40 in the first angular lever position range.

The mounting device 30 is configured symmetrically with respect to the rotation axis 32. When turning the lever element 14 backwards, the resistance against turning changes accordingly and identically to forward movement. In other embodiments, the mounting device 30 is configured to change the resistance differently during backward rotation of the lever element 14 to provide additional tactile feedback.

The mounting device 30 comprises a set of two second spring elements 48 and correspond ball elements 50. The second spring elements 48 are configured as compression springs. The second spring elements 48 are arranged symmetrically about and parallel to the central axis 32. The second spring elements 48 are at least partially arranged between the first mounting element 36 and the second mounting element 38.

The second spring elements may extend through the first mounting element 36 and be supported with one end on the lever element 14, such as on its central shaft 34. This allows an axial arrangement in which the second spring elements 48 at least partially axially overlap with the first spring elements 40. Such a configuration may be particular compact, as can be seen in FIG. 4.

The second spring elements 48 each urge the corresponding one of the ball elements 50 against a ball support surface 54 formed by the second mounting element 38. For that purpose, the mounting device 30 comprises optional interface elements 58 arranged between each second spring element 48 and the corresponding ball element 50. The interface elements 58 each have a mounting section received within the corresponding second spring element 48 and a ball contact section. The ball contact section has a surface facing the ball element 50 that is concavely shaped corresponding to the radius of the sphere of the ball elements 50. The interface elements 58 reduce friction and additionally guide the balls to role around the ball support surface 54 when turning the lever 10. The ball support surface 54 is an annular surface facing towards the first mounting element 36.

As can best be seen in FIG. 8, FIG. 11 and FIG. 14, the ball support surface 54 comprises several through holes 56 with a surrounding annular inclined surface forming a recess as a resting place for the ball elements 50. As can be seen in FIG. 8, a first pair of through holes 56 correspond in position to a center of the neutral angular lever position. As can be seen in FIG. 6 and FIG. 8, when the lever element 14 is centered upright in its neutral position, the ball elements 50 are each partially received in a corresponding through hole 56. This detent provides tactile feedback for the operator for the center position of the lever element 14.

A second pair of through holes 56 correspond in position to the forward edge of the neutral position range with a forward 15° angle of the lever element 14. In this position, the forward gear of the transmission is engaged. Since the ball elements 50 role over the ball support surface 54 together with rotating the lever element 14 and thus the first mounting element 36 and the second spring elements 48, the ball elements 50 will engage with the second pair of through holes 56 in this position. This is illustrated in FIG. 9 and FIG. 11. The provided detent will provide tactile feedback to the operator, indicating that the forward gear is engaged and signaling that forward thrust will now be provided by the power train of the vessel. Upon further forward rotation, resistance to pushing the lever element 14 will increase continuously without further detents until the lever element 14 arrives at an end stop. Such a position is illustrated in FIG. 12 and FIG. 14.

As can also be seen in the figures, there is a third pair of through holes 56 corresponding in position to the backward edge of the neutral position range with a backward 15° angle of the lever element 14. At this position, a backward gear of the transmission will be engaged. Similar to the forward 15° angle, a detent will be provided that provides tactile feedback to the operator, indicating that the backward gear is engaged and signaling that backward thrust will now be provided by the power train of the vessel.

### LIST OF REFERENCE SIGNS

10 lever
12 base
14 lever elements
16 deck
18 arrow: forward angular lever position
20 arrow: forward pushing direction
22 arrow: backward angular lever position
24 arrow: backward pushing direction
30 mounting device
32 rotation axis
34 central shaft
36, 38 mounting elements
40 first spring elements
42, 44 annular contact surfaces
46 blind holes
48 second spring elements
50 ball elements
54 ball support surface
56 through holes
58 interface elements

1. device (30) for a lever (10) configured for controlling a marine vessel, the mounting device (30) being configured to hold a lever element (14) rotatably about a rotation axis (32), wherein the mounting device (30) is configured to adjust an amount of resistance against moving the lever element (14) depending on an angular lever position, wherein, in a first angular lever position range, the amount of resistance against further angular deflection increases with an increased deflection of the lever element (14) beyond a neutral position.

2. The mounting device (30) according to claim 1, wherein the mounting device (30) comprises:
a first mounting element (36);
a second mounting element (38); and
a first spring element (40), wherein the first and second mounting elements (36, 38) are rotatable relative to each other to allow a rotation of the lever element (14) about the rotation axis (32);
wherein the first mounting element (36) is mounted axially moveably along the rotation axis (32), wherein a first section of a contact surface (42, 44) of at least one of the first and second mounting elements (36, 38) contacting the other of the first and second mounting elements (36, 38) in the first angular lever position range is shaped so that rotation of the lever element (14) about the rotation axis (32) causes a change in tension in the first spring element (40) in the first angular lever position range.

3. The mounting device (30) according to claim 2, wherein the first section of the contact surface (42, 44) is shaped to axially move the first mounting element (36) away from the second mounting element (38) with an increase in deflection of the lever element (14) beyond the neutral position in the first angular lever position range.

4. The mounting device (30) according to claim 2, wherein the first section of the contact surface (42, 44) is inclined towards the other one of the first and second mounting elements (36, 38).

5. The mounting device (30) according to claim 2, wherein each of the first and second mounting elements (36, 38) has a contact surface (42, 44) with a first section, wherein the the first section of the first mounting element contacts the first section of the second mounting element when the first and second mounting elements are in the first angular lever position range.

6. The mounting device (30) according to claim 2, wherein in a second angular lever position range, the amount of resistance is substantially constant regardless of the deflection of the lever element (14) from the neutral position.

7. The mounting device (30) according to claim 6, wherein a second section of the contact surface (42, 44) contacting the other of the first and second mounting elements (36, 38) in the second angular lever position range is shaped so that rotation of the lever element (14) about the rotation axis (32) causes substantially no change in tension in the first spring element (40) in the second angular lever position range.

8. The mounting device (30) according to claim 7, wherein the second section of the contact surface (42, 44) extends substantially orthogonally to the rotation axis (32).

9. The mounting device (30) according to claim 1, wherein the mounting device (30) defines a detent between the first angular lever position range and the second angular lever position range.

10. The mounting device (30) according to claim 1, wherein the mounting device (30) defines a detent at the neutral position of the lever element (14).

11. The mounting device (30) according to claim 10, wherein the mounting device (30) comprises a second spring element (48) and a ball element (50), wherein the second spring element (48) is mounted to one of the first and second mounting elements (36, 38) and urges the ball element (50) against a ball support surface (54) of the other of the first and second mounting elements (36, 38), and wherein the ball support surface (54) at least in part defines the detent.

12. The mounting device (30) according to claim 11, wherein the ball support surface (54) defines a recess for the detent, wherein the ball element (50) is arranged at least partially in the recess when the lever element (14) is arranged at an angular lever position of the detent.

13. A lever (10) configured for controlling a marine vessel, the lever (10) comprising:
the mounting device (30) according to claim 1;
a lever element (14); and
a central shaft (34) extending from the lever element (14) along the rotation axis (32), wherein the mounting device (30) is mounted to the central shaft (34).

14. The lever (10) according to claim 13, wherein the first mounting element (36) is mounted to the central shaft (34) with a spline which allows axial movement but no rotational movement relative to the shaft.

15. A marine vessel comprising:
a lever (10) according to claim 13;
an engine; and
a transmission, wherein the lever (14) is configured to control an engine output depending on the angular lever position and wherein the lever (14) is configured to control a gear engagement of the transmission depending on the angular lever position.
